(19) United States
(12) Patent Application Publication
(10) Pub. No.: US 2023/0327151 A1
(43) Pub. Date: Oct. 12, 2023

(54) HUMIDIFIER CONTROL APPARATUS AND METHOD AND FUEL CELL SYSTEM USING THE SAME

(71) Applicant: HYUNDAI MOBIS Co., Ltd., Seoul (KR)

(72) Inventor: Yong Hee LEE, Yongin-si (KR)

(73) Assignee: HYUNDAI MOBIS Co., Ltd., Seoul (KR)

(21) Appl. No.: 18/089,173

(22) Filed: Dec. 27, 2022

(30) Foreign Application Priority Data
Apr. 12, 2022 (KR) 10-2022-0045008

(51) Int. Cl. H01M 8/04119; H01M 8/04828; H01M 8/04746

(52) U.S. Cl. CPC H01M 8/04141; H01M 8/04843; H01M 8/04835; H01M 8/04753; H01M 8/04156

(57) ABSTRACT

The disclosure provides a humidifier control apparatus including a humidifier; a reservoir tank configured to store condensed water discharged from the humidifier; a heating unit configured to apply heat to the reservoir tank; and a drain valve configured to discharge the condensed water stored in the reservoir tank.

This application claims priority to and the benefit of Korean Patent Application No. 10-2022-0045008, filed on Apr. 12, 2022, the disclosure of which is incorporated herein by reference in its entirety.

### BACKGROUND

### 1. Field of the Invention

The disclosure relates to a humidifier control apparatus and method capable of controlling a humidification amount and a fuel cell system using the same.

### 2. Discussion of Related Art

A fuel cell system is a kind of power generation system which electrochemically and directly converts chemical energy of fuel into electrical energy in a fuel cell (stack) without burning the chemical energy of the fuel.

A type of fuel cell which draws most attention for vehicles is a hydrogen ion (or proton) exchange membrane fuel cell (PEMFC), which has the highest power density among fuel cells, or a polymer electrolyte membrane fuel cell (PEMFC). PEMFC is a high-output fuel cell with a high current density as compared to other fuel cells, operates at a relatively low temperature, and has a simple structure. The PEMFC is also suitable as a power source for vehicles because the PEMFC has fast start-up and responsiveness and excellent durability and can use methanol or natural gas as fuel in addition to hydrogen.

The fuel cell system using such a fuel cell typically includes a humidifier which humidifies air being supplied to a fuel cell stack. The humidifier serves to transfer moisture between air discharged from the fuel cell stack and air supplied to the fuel cell stack using a compressor. The humidifier also serves as a catalyst for a hydrogen reaction of the fuel cell. When the air is compressed by the compressor, a temperature rises to about 80° C., and a density of the air decreases. Accordingly, since air should be supplied to the fuel cell stack in a state in which the air density is increased, the temperature is lowered to about 30° C. to 40° C. by an air cooler, and then air is transferred to an inlet of the humidifier. The air transferred to the humidifier is supplied into a hollow fiber membrane of the humidifier, moisture discharged from an outlet of the fuel cell stack passes through the hollow fiber membrane of the humidifier, only the moisture is transferred into the hollow fiber membrane, and thus the air at the outlet of the humidifier is moisturized.

As described above, when the moisture is present at the outlet of the humidifier, the moisture in the humidifier freezes during the cold winter season. In particular, when residual moisture in the humidifier is not completely discharged, freezing occurs in a pipe, and when the residual moisture is left for a long time, there was a problem affecting an operation of an air pressure control (APC) valve due to cold soaking.

Accordingly, in order to solve the above problems, there is a need to control the humidifier so that the residual moisture is not present in the humidifier.

### SUMMARY OF THE INVENTION

The disclosure is directed to providing a humidifier control apparatus capable of controlling a humidification amount and a fuel cell system using the same.

According to an aspect of the disclosure, there is provided a humidifier control apparatus including a humidifier; a reservoir tank configured to store condensed water discharged from the humidifier; a heating unit configured to apply heat to the reservoir tank; and a drain valve configured to discharge the condensed water stored in the reservoir tank.

The humidifier may include a first inlet to which dry air is supplied; a second inlet to which humid air is supplied; a first outlet from which humidified air is discharged; and a second outlet through which the condensed water is supplied to the reservoir tank.

The humidifier control apparatus may further include a first sensor disposed at the first inlet to measure a first humidity of the dry air and a second sensor disposed at the first outlet to measure a second humidity of the humidified air.

The humidifier control apparatus may further include a controller configured to control the heating unit or the drain valve on the basis of the first humidity and the second humidity measured by the first sensor and the second sensor and an amount of the condensed water stored in the reservoir tank.

The controller may receive information about the first humidity measured by the first sensor, the second humidity measured by the second sensor, and the amount of the condensed water stored in the reservoir tank to control the heating unit or the drain valve.

The humidifier may include a hollow fiber membrane.

The heating unit includes a positive temperature coefficient (PTC) heater and evaporates the condensed water.

According to another aspect of the disclosure, there is provided a humidifier control method including: supplying air to a humidifier; humidifying the supplied air and then supplying the humidified air; storing condensed water generated in the humidification process of the humidifier in a reservoir tank, and measuring an amount of the condensed water stored in the reservoir tank; comparing the amount of condensed water with a first reference value; and heating the reservoir tank with a heating unit to evaporate the condensed water stored in the reservoir tank and supplying it to the humidifier.

The humidifier control method further incudes, if the amount of condensed water is greater than or equal to the first reference value, obtaining a first humidity value by measuring a humidity at inlet of the humidifier using a first sensor, and obtaining a second humidity value by measuring a humidity at outlet of the humidifier outlet using a second sensor; calculating a difference value between the first humidity value and the second humidity value; comparing the difference value and a second reference value; and if the difference value is less than the second reference value, returning to the step of comparing the amount of condensed water with the first reference value.

The humidifier control method further incudes, if the difference value is greater than or equal to the second reference value, discharging the condensed water stored in the reservoir tank.

According to another aspect of the disclosure, there is provided a fuel cell system including a fuel cell stack which includes an anode to which hydrogen is supplied and a cathode to which humidified air is supplied and discharges condensed water generated by a reaction of the hydrogen and the humidified air; and a humidifier control apparatus which receives air, converts the air into the humidified air, supplies the humidified air to the cathode of the fuel cell stack, humidifies water vapor generated by heating the condensed water discharged from the fuel cell stack, and supplies humidified water vapor to the fuel cell stack or discharges the condensed water.

The fuel cell system may further include a fuel supply apparatus which supplies the hydrogen to the anode of the fuel cell stack.

The fuel supply apparatus may include a flow control valve configure to control a supply amount of the hydrogen; a fuel supply valve configured to adjust a pressure of the hydrogen supplied from the flow control valve; and a fuel ejector configured to supply the hydrogen to the anode of the fuel cell stack by applying a pressure to the hydrogen of which the pressure and the supply amount are adjusted. The fuel cell system may further include a purge valve configured to discharge impurities generated at the anode in the fuel cell stack.

The fuel cell system may further include a cut-off valve which selectively blocks the humidified air supplied from the humidifier control apparatus to the cathode of the fuel cell stack.

The cut-off valve discharges residual moisture discharged from the cathode of the fuel cell stack to the humidifier control apparatus.

The fuel cell system may further include a condensed water storage and discharge unit configured to store a predetermined amount of the condensed water generated and discharged from the anode of the fuel cell stack and then discharges the condensed water.

The condensed water storage and discharge unit may include a fuel-line water trap configured to store the condensed water up to a predetermined water level; and a fuel-line drain valve configured to discharge the condensed water stored in the water trap to the humidifier control apparatus.

The fuel cell system may further include an air supply apparatus configured to supply the air to the humidifier control apparatus.

The humidifier control apparatus of the fuel cell system may include a humidifier; a reservoir tank configured to store condensed water discharged from the humidifier; a heating unit configured to apply heat to the reservoir tank; and a drain valve configured to discharge the condensed water stored in the reservoir tank.

The fuel cell system may further include a controller configured to control a humidity of air supplied to the cathode of the fuel cell stack by controlling the drain valve and the heating unit on the basis of a humidity measured by each of a first sensor and a second sensor and an amount of condensed water supplied from the reservoir tank.

The controller may control the amount and the pressure of the hydrogen supplied to the anode of the fuel cell stack by controlling the flow control valve, the fuel supply valve, and the fuel ejector of the fuel supply apparatus.

The controller may control the cut-off valve to control the cut-off valve to control the air supplied from the humidifier control apparatus to the cathode of the fuel cell stack.

The controller may block the residual moisture from being discharged or discharge the residual moisture to the humidifier control apparatus when the residual moisture contained in the air supplied to the cathode of the fuel cell stack is discharged from the fuel cell stack.

### BRIEF DESCRIPTION OF THE DRAWINGS

The above and other objects, features and advantages of the disclosure will become more apparent to those of ordinary skill in the art by describing exemplary embodiments thereof in detail with reference to the accompanying drawings, in which:

FIG. 1 is a block diagram illustrating a humidifier control apparatus according to an embodiment of the disclosure;

FIG. 2 is a flowchart illustrating a method of controlling a humidifier according to an embodiment of the disclosure;

FIG. 3 is a block diagram illustrating a fuel cell system according to an embodiment of the disclosure; and

FIG. 4 is a flowchart illustrating a method of controlling a fuel cell system according to an embodiment of the disclosure.

### DETAILED DESCRIPTION OF EXEMPLARY EMBODIMENTS

Embodiments of the disclosure may be modified into different forms, or a plurality of embodiments may be combined, and the scope of the disclosure is not limited to embodiments which will be described below.

Although a description given in a specific embodiment is not given in other embodiments, the description may be understood as descriptions of the other embodiments, unless otherwise stated to the contrary or contradictory.

For example, when a feature of an element A is described in a specific embodiment, and a feature of an element B is described in another embodiment, the scope of the disclosure includes an embodiment in which the elements A and B are combined even when the elements A and B are not clearly described in the embodiment, unless otherwise stated to the contrary or contradictory.

Terms, such as first, second, or the like, are used to describe various components. The terms are only to distinguish one element from another element, and the essence, order, and the like of the elements are not limited by the terms.

The terminology used herein is for the purpose of describing particular embodiments only and is not intended to limit the disclosure. The singular forms are intended to include the plural forms, unless the context clearly indicates otherwise. In the present specification, it should be understood that the terms, such as “comprise,” “including,” or the like, specify the presence of stated features, numbers, steps, operations, elements, components, or combinations thereof but do not preclude the presence or addition of one or more other features, numbers, steps, operations, elements, components, or combinations thereof.

In addition, throughout the specification, when “connected,” not only this means that two or more components are directly connected, but this also means that two or more components are indirectly connected through other components or are physically connected as well as electrically connected, or are one thing even referred to as different names according to positions or functions thereof.

Hereinafter, when a humidifier control apparatus and a method of controlling the same according to the disclosure will be described in detail with reference to the accompanying drawings, components that are the same or correspond to each other will be denoted by the same reference numerals, and redundant description will be omitted.

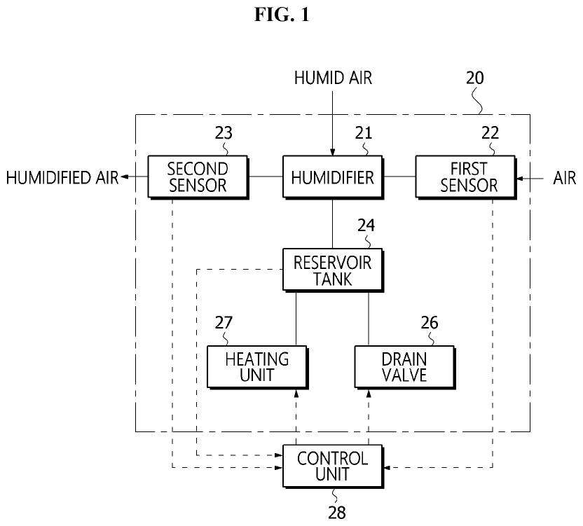

Hereinafter, a humidifier control apparatus according to the embodiment of the disclosure will be described with reference to FIG. 1.

FIG. 1 is a block diagram illustrating a humidifier control apparatus according to the embodiment of the disclosure.

Referring to FIG. 1, a humidifier control apparatus 20 according to the embodiment of the disclosure may include a humidifier 21, a first sensor 22, a second sensor 23, a reservoir tank 24, a drain valve 26, a heating unit 27, and a controller 28.

The humidifier 21 may supply humid air using a membrane which selectively transmits only water vapor included in atmospheric air or exhaust gas. For example, the humidifier 21 may supply humidified air by humidifying dry air through a moisture transfer/exchange method using a membrane such as a hollow fiber membrane.

The first sensor 22 may be disposed at an inlet of the humidifier 21 to measure a humidity (hereinafter, referred to as a “first humidity”) of air introduced from the outside by, for example, an air compressor.

The second sensor 23 may be disposed at an outlet of the humidifier 21 to measure a humidity (hereinafter, referred to as a “second humidity”) of humidified air humidified by the humidifier.

The first humidity and the second humidity measured by the first and second sensors 22 and 23 may be supplied to a controller 28 which will be described below.

The reservoir tank 24 may store condensed water generated during a humidification process of the humidifier 21.

The heating unit 27 may heat the condensed water stored in the reservoir tank 24 to supply additional moisture to the humidifier 21. The heating unit 27 may use a positive temperature coefficient (PTC) heater and may evaporate the condensed water using high voltage residual power.

When an amount of the condensed water stored in the reservoir tank 24 is greater than a reference value, the drain valve 26 may discharge the condensed water (stored water) to the outside.

The controller 28 may receive information on the first humidity measured by the first sensor 22, the second humidity measured by the second sensor 23, and the amount of water stored in the reservoir tank 24 and control the heating unit 27 and/or the drain valve 26.

For example, when the amount of water stored (that is, the amount of stored water or the amount of condensed water) in the reservoir tank 24 is less than the first reference value, the controller 28 may increase a humidification amount by heating the heating unit 27. On the other hand, when the amount of water stored in the reservoir tank 24 is greater than or equal to the first reference value, the controller 28 may control the drain valve 26 to be opened to maintain an appropriate amount of the condensed water discharged from the humidifier 21 in the reservoir tank 24.

In addition, the controller 28 may calculate a difference value between the first humidity measured by the first sensor 22 and the second humidity measured by the second sensor 23, and when the difference value is less than a second reference value, the controller 28 may compare a stored amount of water stored in the reservoir tank 24 with the first reference value and repeat the above process. On the other hand, when the difference value between the first humidity and the second humidity is greater than or equal to the second reference value, the controller 28 may control the drain valve 26 to be opened to maintain an appropriate amount of condensed water discharged from the humidifier 21 in the reservoir tank 24.

According to an exemplary embodiment of the present disclosure, the controller 28 may include a processor (e.g., computer, microprocessor, CPU, ASIC, circuitry, logic circuits, etc.) and an associated non-transitory memory storing software instructions which, when executed by the processor, provides the functionalities as described above. Herein, the memory and the processor may be implemented as separate semiconductor circuits. Alternatively, the memory and the processor may be implemented as a single integrated semiconductor circuit. The processor may embody one or more processor(s).

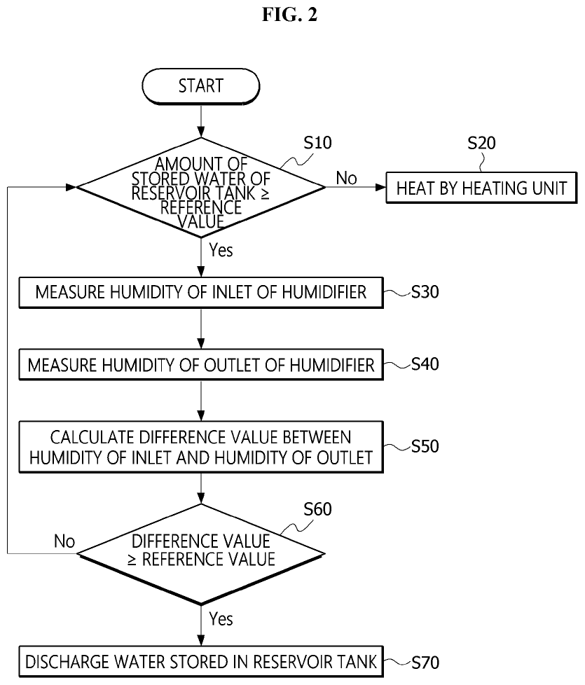

Hereinafter, the method of controlling the humidifier according to the embodiment of the disclosure will be described with reference to FIG. 2.

FIG. 2 is a flowchart illustrating the method of controlling the humidifier according to the embodiment of the disclosure.

Referring to FIG. 2, an amount of water stored in the reservoir tank 24 which stores condensed water discharged from the humidifier 21 is measured and compared with a predetermined value (hereinafter, referred to as a “first reference value”) (S10).

When the amount of stored water (or condensed water) in the reservoir tank 24 is smaller than the first reference value, the heating unit 27 heats the reservoir tank 24 to evaporate the condensed water stored in the reservoir tank 24 (S20).

On the other hand, when the amount of water stored in the reservoir tank 24 is greater than or equal to the first reference value, a first humidity value is obtained by measuring a humidity at the inlet of the humidifier 21 using the first sensor 22 (S30), and then a second humidity value is obtained by measuring a humidity at the outlet of the humidifier 21 using the second sensor 23 (S40).

Next, a difference value is calculated by comparing the first humidity value at the inlet of the humidifier 21 measured by the first sensor 22 and the second humidity value at the outlet of the humidifier 21 measured by the second sensor 23 (S50).

The difference value between the first humidity value at the inlet of the humidifier 21 and the second humidity value at the outlet of the humidifier 21 is compared with a predetermined value (hereinafter, referred to as a “second reference value”) (S60).

As a result of the comparison, when the difference value is smaller than the second reference value, a subsequent step goes back to step S10, and steps S10 to S50 are repeated. On the other hand, when the difference value is greater than or equal to the second reference value, the condensed water stored in the reservoir tank 24 is discharged to maintain an appropriate amount of the condensed water discharged from the humidifier 21 in the reservoir tank 24 (S70).

According to the humidifier control apparatus and the method of controlling the same of the disclosure described above, an effect of efficiently controlling a humidification amount according to a humidity at the inlet and a humidity at the outlet of the humidifier and the amount of water stored in the reservoir tank which stores condensed water discharged from the humidifier can be obtained.

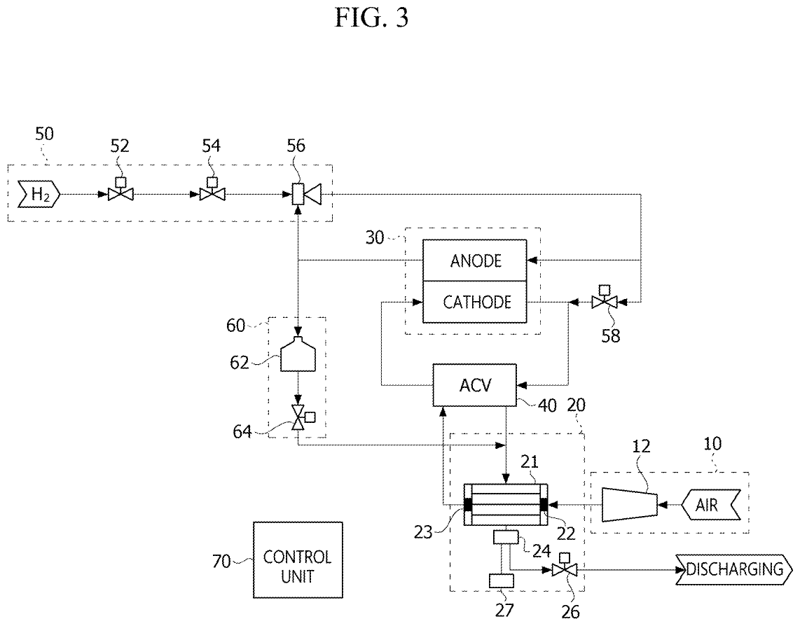

Next, a fuel cell system according to an embodiment of the disclosure will be described in detail with reference to FIG. 3.

FIG. 3 is a block diagram illustrating a fuel cell system according to the embodiment of the disclosure.

Referring to FIG. 3, the fuel cell system according to the embodiment of the disclosure includes an air supply apparatus 10, a humidifier control apparatus 20, a fuel cell stack 30, an air cut-off valve (ACV) 40, a fuel supply apparatus 50, a condensed water storage and discharge unit 60, and a controller 70.

The air supply apparatus 10 may supply air (oxygen) which is an oxidant required for an electrochemical reaction of the fuel cell stack 30. The air supply apparatus 10 may include an air compressor (ACP) 12 for supplying external air and supply air from which dust is filtered through an air cleaner to the humidifier control apparatus 20.

The humidifier control apparatus 20 may include a humidifier 21, a first sensor 22, a second sensor 23, a reservoir tank 24, a drain valve 26, and a heating unit 27. The apparatus illustrated in FIG. 1 may be used as the humidifier control apparatus 20. However, in the fuel cell system, the controller 70 illustrated in FIG. 3 may be used instead of the controller 28 illustrated in the embodiment of FIG. 1.

The humidifier 21 may be implemented as a membrane humidifier including a hollow fiber membrane. The humidifier 21 may control a humidity of air supplied from the ACP 12 of the air supply apparatus 10 to supply air with moisture to the fuel cell stack 30.

The first sensor 22 and the second sensor 23 may be respectively disposed at an inlet and an outlet of the humidifier 21 to supply information on the first and second humidity values to the controller 70.

The reservoir tank 24 may supply information on an amount of water stored in the reservoir tank 24 to the controller 70.

The drain valve 26 and the heating unit 27 may be operated according to control of the controller 70 to adjust the amount of water stored in the reservoir tank 24.

The fuel cell stack 30 may include a cathode and an anode of a membrane-electrode assembly (MEA) to which oxygen (air) and hydrogen, which are fuels of the fuel cell stack 30, are supplied through a flow path of a separator. In the fuel cell stack 30, the air (oxygen) with moisture supplied from the humidifier 21 may be supplied to the anode in the fuel cell stack 30, and hydrogen (H₂) supplied from the fuel supply apparatus 50 may be supplied to the cathode in the fuel cell stack 30. The fuel cell stack 30 may generate a current through a fuel cell reaction when the hydrogen and oxygen are supplied.

The ACV 40 (Air Cut-off Valve) may be implemented as a solenoid valve and may control supply of oxygen to maintain a humidity of oxygen (air) which is important in a reaction of the fuel cell stack 30. The ACV 40 may block air (oxygen) from being supplied from the humidifier 21 to the cathode of the fuel cell stack 30 according to control of the controller 70. When residual moisture contained in the air supplied to the cathode of the fuel cell stack 30 is discharged, the ACV 40 may block the residual moisture from being discharged or discharge the residual moisture to the humidifier 21 according to the control of the controller 70.

The fuel supply apparatus 50 may supply hydrogen (H₂), which is a fuel, to the fuel cell stack 30. The fuel supply apparatus 50 may include a flow control valve (FCV) 52, a fuel supply valve (FSV) 54, and a fuel ejector (FEJ) 56.

The FCV 52 may control a supply amount of hydrogen. The FSV 54 may adjust a hydrogen pressure applied to the fuel cell stack 30. The FEJ 56 may apply a pressure to the hydrogen to supply the hydrogen to the anode of the fuel cell stack 30. The fuel supply apparatus 50 may control an amount and a pressure of the hydrogen supplied as a fuel by using the FCV 52 and the FSV 54, and then supply the hydrogen to the anode of the fuel cell stack 30 through the FEJ 56.

A fuel-line purge valve (FPV) 58 may discharge impurities (nitrogen and the like) generated at the anode in the fuel cell stack 30.

The condensed water storage and discharge unit 60 includes a fuel-line water trap (FWT) 62 which stores condensed water generated at the anode in the fuel cell stack 30 to a certain level and a fuel-line drain valve (FDV) 64 which discharges the condensed water. The FDV 64 may be controlled by controller 70 to supply condensed water discharged from the FWT 62 to the humidifier 21 for recycling.

The controller 70 may control the drain valve 26 and the heating unit 27 of the humidifier control apparatus 20 to control a humidity of air supplied to the cathode of the fuel cell stack 30 on the basis of the first and second humidity values measured by the first and second sensors 22 and 23 and the amount of stored water supplied from the reservoir tank 24.

The controller 70 may also control the FCV 52, the FSV 54, and the FEJ 56 of the fuel supply apparatus to control an amount and a pressure of hydrogen supplied to the anode of the fuel cell stack 30.

The controller 70 may also control the ACV 40 to control air (oxygen) supplied from the humidifier 21 to the cathode of the fuel cell stack 30, or when residual moisture contained in air supplied to the cathode of the fuel cell stack 30 is discharged from the fuel cell stack 30, the controller 70 may block the air or may discharge the air to the humidifier 21.

The controller 70 may also control the FDV 64 to supply the condensed water discharged from the FWT 62 to the humidifier 21 for recycling.

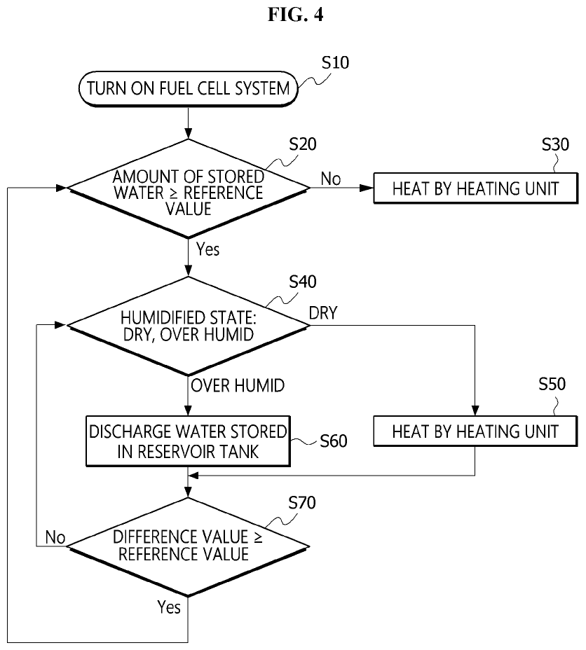

Next, the fuel cell system according to the embodiment of the disclosure will be described in detail with reference to FIG. 4.

FIG. 4 is a flowchart illustrating a method of controlling the fuel cell system according to the embodiment of the disclosure.

Referring to FIG. 4, the fuel cell system according to the embodiment of the disclosure is turned on and operated (S10).

Next, an amount of stored water of the reservoir tank 24 which stores condensed water discharged from the humidifier 21 is measured and compared with a predetermined value (hereinafter, referred to as a “first reference value”) (S20).

As a result of the comparison, when the amount of stored water of the reservoir tank 24 is less than the first reference value, the heating unit 27 heats the reservoir tank 24 to evaporate the condensed water stored in the reservoir tank 24 (S30).

On the other hand, when the amount of water stored in the reservoir tank 24 is greater than or equal to the first reference value, a humidification state of the fuel cell stack 30 is measured and compared with a predetermined value (hereinafter, referred to as a “second reference value”) to determine whether the state is a dry state or over-humid state (S40).

The second reference value may be a humidity within a predetermined range in which the fuel cell stack may perform a normal capability. The dry state may indicate a case in which the amount is smaller than that of the second reference range, and the over-humid state may indicate a case in which the amount is greater than that of the second reference range.

As a result of the determination, when the humidification state of the fuel cell stack 30 is the dry state, the heating unit 27 may be operated to evaporate the water stored in the reservoir tank 24 so that moisture is supplied to the humidifier 21, and the humidifier 21 may supply the added moisture to the fuel cell stack 30 so that a humidity of the fuel cell stack 30 is increased.

When the humidification state of the fuel cell stack 30 is the over-humid state, the drain valve 26 may be operated to discharge the water stored in the reservoir tank 24.

Accordingly, since additional moisture is not supplied to the humidifier 21 from the reservoir tank 24 in addition to the air supplied from the air supply apparatus 10, and the amount of water stored in the reservoir tank is decreased, the condensed water discharged from the humidifier may be smoothly discharged to decrease the humidity of the fuel cell stack 30.

According to the fuel cell system and the method of controlling the same of the disclosure described above, an effect of efficiently controlling a humidification amount according to a humidification state of the fuel cell stack can be obtained.

While the disclosure has been described above with reference to exemplary embodiments, it may be understood by those skilled in the art that various modifications and changes of the disclosure may be made within a range not departing from the spirit and scope of the disclosure defined by the appended claims.

What is claimed is:

1. A humidifier control apparatus comprising:
a humidifier;
a reservoir tank configured to store condensed water discharged from the humidifier;
a heating unit configured to apply heat to the reservoir tank; and
a drain valve configured to discharge the condensed water stored in the reservoir tank.

2. The humidifier control apparatus of claim 1, wherein the humidifier includes:
a first inlet to which dry air is supplied;
a second inlet to which humid air is supplied;
a first outlet from which humidified air is discharged; and
a second outlet through which the condensed water is supplied to the reservoir tank.

3. The humidifier control apparatus of claim 2, further comprising:
a first sensor disposed at the first inlet to measure a first humidity of the dry air; and
a second sensor disposed at the first outlet to measure a second humidity of the humidified air.

4. The humidifier control apparatus of claim 3, further comprising: [symbol] troller configured to control the heating unit or the drain valve based on the first humidity and the second humidity measured by the first sensor and the second sensor and an amount of the condensed water stored in the reservoir tank.

5. The humidifier control apparatus of claim 4, wherein the controller receives information about the first humidity measured by the first sensor, the second humidity measured by the second sensor, and the amount of the condensed water stored in the reservoir tank to control the heating unit or the drain valve.

6. The humidifier control apparatus of claim 1, wherein the humidifier includes a hollow fiber membrane.

7. The humidifier control apparatus of claim 1, wherein the heating unit includes a positive temperature coefficient (PTC) heater and evaporates the condensed water

[symbol]

8. A humidifier control method comprising:
supplying air to a humidifier;
humidifying the air and supplying the humidified air;
storing condensed water generated in a humidification process of the humidifier in a reservoir tank, and measuring an amount of the condensed water stored in the reservoir tank;
comparing the amount of condensed water with a first reference value; and
heating the reservoir tank with a heating unit to evaporate the condensed water stored in the reservoir tank and supplying it to the humidifier.

9. The humidifier control method claim 8, further comprising:
in response to the amount of condensed water which is greater than or equal to the first reference value, obtaining a first humidity value by measuring a humidity at inlet of the humidifier using a first sensor, and obtaining a second humidity value by measuring a humidity at outlet of the humidifier outlet using a second sensor;
calculating a difference value between the first humidity value and the second humidity value;
comparing the difference value and a second reference value; and
in response to the difference value which is less than the second reference value, returning to the step of comparing the amount of condensed water with the first reference value.

10. The humidifier control method of claim 9, further comprising: in response to the difference value which is greater than or equal to the second reference value, discharging the condensed water stored in the reservoir tank.

11. A fuel cell system comprising:
a fuel cell stack which includes an anode to which hydrogen is supplied and a cathode to which humidified air is supplied and discharges condensed water generated by a reaction of the hydrogen and the humidified air; and
a humidifier control apparatus which receives air, converts the air into the humidified air, supplies the humidified air to the cathode of the fuel cell stack, humidifies water vapor generated by heating the condensed water discharged from the fuel cell stack, and supplies humidified water vapor to the fuel cell stack or discharges the condensed water.

12. The fuel cell system of claim 11, further comprising: a fuel supply apparatus which supplies the hydrogen to the anode of the fuel cell stack.

13. The fuel cell system of claim 12, wherein the fuel supply apparatus includes:
a flow control valve configured to control a supply amount of the hydrogen;
a fuel supply valve configured to adjust a pressure of the hydrogen supplied from the flow control valve; and
a fuel ejector configured to supply the hydrogen to the anode of the fuel cell stack by applying a pressure to the hydrogen of which the pressure and the supply amount are adjusted.

14. The fuel cell system of claim 8, further comprising: a cut-off valve which selectively blocks the humidified air supplied from the humidifier control apparatus to the cathode of the fuel cell stack.

15. The fuel cell system of claim 14, wherein the cut-off valve discharges residual moisture discharged from the cathode of the fuel cell stack to the humidifier control apparatus.

16. The fuel cell system of claim 9, further comprising: a condensed water storage and discharge unit configured to store a predetermined amount of the condensed water generated and discharged from the anode of the fuel cell stack and then discharges the condensed water.

17. The fuel cell system of claim 11, wherein the humidifier control apparatus includes:
a humidifier;
a reservoir tank configured to store condensed water discharged from the humidifier;
a heating unit configured to apply heat to the reservoir tank; and
a drain valve configured to discharge the condensed water stored in the reservoir tank.

18. The fuel cell system of claim 17, further comprising: a controller configured to control a humidity of air supplied to the cathode of the fuel cell stack by controlling the drain valve and the heating unit based on a first humidity of dry air and a second humidity of humidified air measured by a first sensor and a second sensor, respectively, and an amount of condensed water supplied from the reservoir tank.

19. The fuel cell system of claim 13, further comprising a controller configured to control the amount and the pressure of the hydrogen supplied to the anode of the fuel cell stack by controlling the flow control valve, the fuel supply valve, and the fuel ejector of the fuel supply apparatus.

20. The fuel cell system of claim 16, further comprising: a controller configured to control the cut-off valve to control the air supplied from the humidifier control apparatus to the cathode of the fuel cell stack, or to block the residual moisture from being discharged or discharge the residual moisture to the humidifier control apparatus when the residual moisture contained in the air supplied to the cathode of the fuel cell stack is discharged from the fuel cell stack.
